(19) United States
(12) Patent Application Publication
(10) Pub. No.: US 2009/0089258 A1
(43) Pub. Date: Apr. 2, 2009

(54) FILE MANAGEMENT SYSTEM AND METHOD FOR PORTABLE ELECTRONIC DEVICE

(75) Inventor: JIE-YAN KE, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/143,831

(22) Filed: Jun. 23, 2008

(30) Foreign Application Priority Data
Sep. 28, 2007 (CN) 200710201894.0

(51) Int. Cl. G06F 17/30

(52) U.S. Cl. 707/3; 707/E17.001

(57) ABSTRACT

A file management system for managing files stored in a camera includes a view generating unit, a searching unit, a selecting unit, and a processing unit. The view generating unit is configured for generating a search query view in response to a first user input, which is configured for receiving a search query in response to a second user input. The searching unit is configured for searching files, if any, matching the received search query, and instructing the view generating unit to generate a list view which is configured for listing entries that satisfy the search query. The selecting unit is configured for selecting listed entries in response to a third user input. The processing unit is configured for accessing files corresponding to the selected entries, and performing a function on the accessed files in response to a fourth user input.

### BACKGROUND

1. Technical Field

The present invention relates to file management systems, and particularly to a file management system for a portable electronic device and a file management method thereof.

2. Description of the Related Art

Being limited by display size, a typical file management application for a portable electronic device, such as a camera, usually handles only one file at a time. Using such a file management application to manage photos is inconvenient to users because they must browse through photos individually for editing, saving, deleting, etc.

Therefore, it is desirable to provide a file management system for a portable electronic device and a file management method thereof, which can overcome the above-mentioned problem.

### SUMMARY

In a present embodiment, a file management system for managing files stored in a camera includes a view generating unit, a searching unit, a selecting unit, and a processing unit. The view generating unit is configured for generating a search query view in response to a first user input. The search query view is configured for receiving a search query in response to a second user input. The searching unit is configured for searching files matching the received search query, subsequently instructing the view generating unit to generate a list view of entries that match the user's search request. The selecting unit is configured for selecting listed entries in response to a third user input. The processing unit is configured for accessing files corresponding to the selected entries, and performing a function on the accessed files in response to a fourth user input.

### BRIEF DESCRIPTION OF THE DRAWINGS

Many aspects of the present file management system and method should be better understood with reference to the accompanying drawings. The components in the drawings are not necessarily drawn to scale, the emphasis instead being placed upon clearly illustrating the principles of the present file management system and method. Moreover, in the drawings, like reference numerals designate corresponding parts throughout the several views.

FIG. 1 is a functional block diagram of a file management system for a camera including a storage unit, an input unit, and a display panel, according to an exemplary embodiment.

FIG. 2 is a first view of the display panel of FIG. 1.

FIG. 3 is a second view of the display panel of FIG. 1.

FIG. 4 is a third view of the display panel, of FIG. 1.

FIG. 5 is a fourth view of the display panel of FIG. 1.

FIG. 6 is a fifth view of the display panel of FIG. 1.

FIG. 7 is a sixth view of the display panel of FIG. 1.

### DETAILED DESCRIPTION OF THE EMBODIMENTS

Embodiments of the present file management system and method will now be described in detail with reference to the drawings.

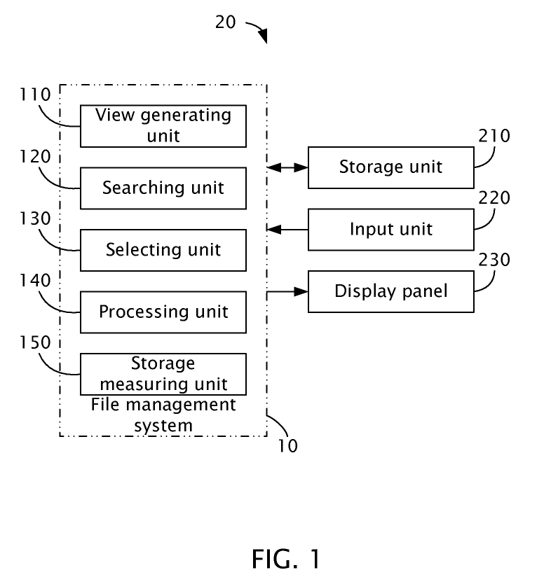

Referring to FIG. 1, a file management system 10 is configured for managing files stored in a camera 20, according to an exemplary embodiment. It should be understood that the application of the management system 10 is not limited by this embodiment. The management system 10 also can be used in other hand-held electronic device such as mobile phones, or media players.

The camera 20 further includes a storage unit 210, an input unit 220, and a display panel 230. The storage unit 210, such as a memory stick, is configured for storing the files. These files, which can include photos, voice files, movies, and other types of files, are stored in conjunction with their associated metadata. This metadata may comprise items such as a small-size icon, file name, file size, resolution, quality, file type, and timestamp. Considering cameras typically provide a storage unit of one gigabyte or more in capacity, they can potentially store up to thousands of files. Therefore, it is inconvenient to manage the files individually in all situations. But, as demonstrated below, the present file management system 10 can efficiently handle these files. The input unit 220, such as a touch screen, is configured for receiving user input. The display panel 230, such as a liquid crystal display panel, is configured for displaying various views.

The file management system 10 includes a view generating unit 110, a searching unit 120, a selecting unit 130, and a processing unit 140.

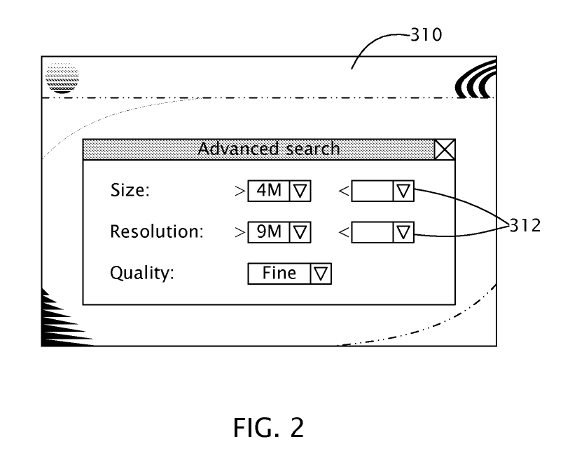

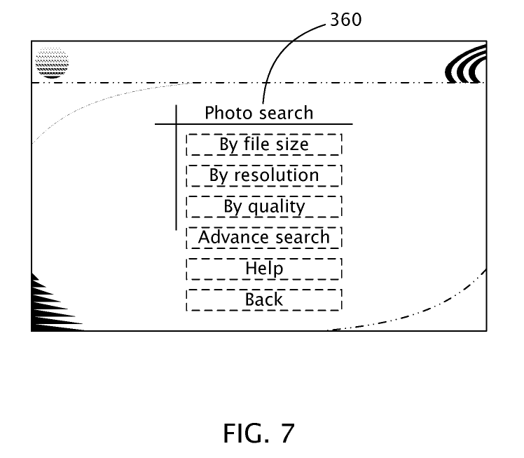

Referring to FIG. 2, the view generating unit 110 is configured for generating a search query view 310 on the display panel 230 in response to a first user input (e.g., a click on a portion of a parent menu of the search query view). This search query view 310 is configured for receiving a search query corresponding to a second user input (e.g., a selection from a pull-down menu). In particular, the search query view 310 may include one or both fields 312 to further refine the search according to the files' metadata. In this embodiment, the search query view 310 is an “advanced search” page presented by the display panel 230. However, the search query view can be flexible and has different layouts (see, e.g., FIG. 7).

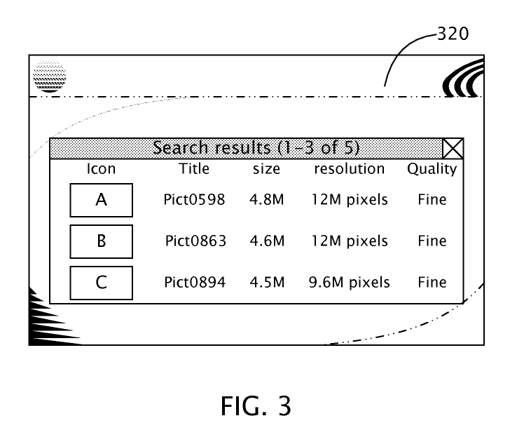

Referring to FIG. 3, the searching unit 120 is configured for returning a list of files matching the parameters from the search query, subsequently triggering the view generating unit 110 to generate a list view 320. The list view 320 is configured for listing a number of entries, if found, that match the corresponding search query. More specifically, the searching unit 120 compares the search query with the metadata of each file, instructs the view generating unit 110 to generate the list view 320, and displays the entries with metadata that satisfy the search query on the list view 320. Particularly, each entry may include the metadata of the file corresponding to the field(s) 312 of the search query view 310. For example, the advanced search page may include the following parameters: size, resolution, and quality. Similarly, the displayed entries include the following metadata information: file size, resolution, quality, icon, and file name.

The selecting unit 130 is configured for selecting one or more listed entries in response to a third user input (e.g., a click on one entry), thereby locating each file that is associated with a corresponding selected entry. Particularly, the selecting unit 130 may also define a focus point on each selected entry to indicate which entry has been selected.

The processing unit 140 is configured for accessing each located file from the storage unit 210 and performing various functions on the accessed files in response to a fourth user input. These functions may include deleting, renaming, resizing, changing the resolution, and changing the quality of the selected file(s).

The present file management system 10 is capable of quickly locating desired files by searching for matches based on the metadata of the files, allowing it to efficiently handle the matches using a batch process.

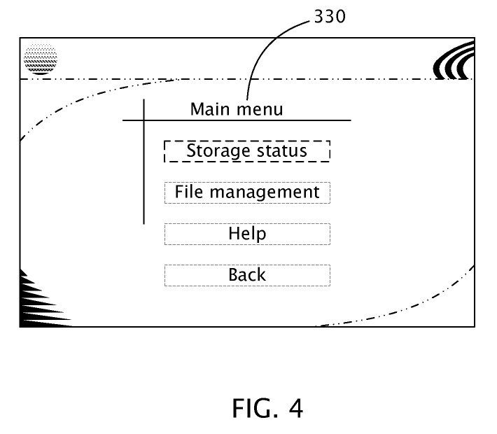

Referring to FIG. 4, in use, the view generating unit 110 may initially present a main menu view 330 on the display panel 230. This main menu view 330 may comprise a first option “Storage status” and a second option “File management”, among other options.

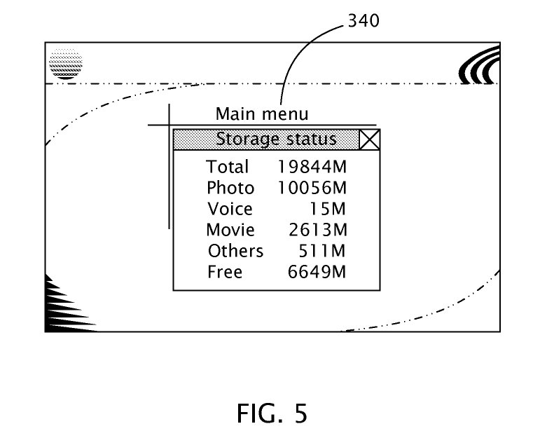

Referring to FIG. 5, if the first option of “Storage status” has been selected, the view generating unit 110 generates a storage status view 340 to show the current usage status of the storage unit 210. Particularly, in order to achieve this function, a storage measuring unit 150 is required in the file management system 10 as shown in FIG. 1 and is configured for measuring a storage occupation of each type of file. For example, the storage measuring unit 150 can measure the storage occupation by summing up the file sizes of files with a corresponding suffix, thereby instructing the view generating unit 110 to generate the storage status view 340.

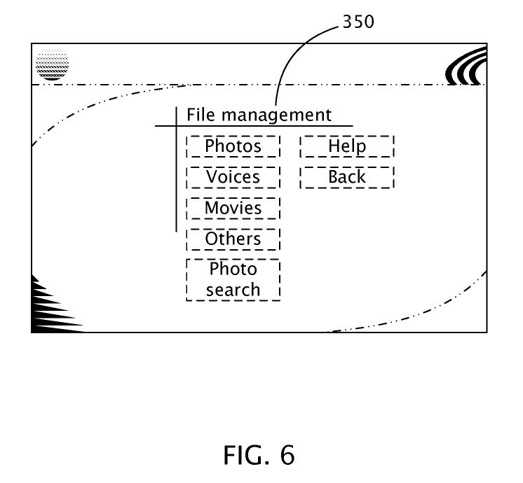

Referring to FIG. 6, if the second option of “File management” has been selected, a file management menu view 350 is generated by the view generating unit 110 and shown on the display panel 230. This file management menu view 350 may include the following options: “Photos,” “Voices,” “Movies,⇄ “Others,” “Photo search,” among others. If one of these options has been selected, the view generating unit 110 generates a corresponding view (not shown) providing a function to individually check each file for corresponding matches. Furthermore, when the “Photo search” option has been selected, a parent menu view of the search query view 310 in FIG. 2 is rendered. In other alternative embodiments, options for searching other types of files such as “Voice search” or “Movie search” can also be provided.

Referring to FIG. 7, if the option “Photo search” in FIG. 6 has been selected, a photo search view 360 (the parent menu view) is presented, on which several options such as “By file size,” “By resolution,” “By quality,” and “Advanced search”, among others, are provided. Each option will trigger a specific page for receiving a corresponding search query.

Referring back to FIG. 2, an example of the search query view 310 is rendered by clicking the option “Advanced search” in FIG. 7 (referred to as ‘first user input’). Here, a second user input is required to define a search query. After the search query is received, the searching unit 120 starts to find matches and list the matches on the list view 320 rendered by the view generating unit 110 as entries. Next, a third user input is required to select entries, thereby locating the desired files. Finally, various manipulations can be applied to the files on the results list by the processing unit 140.

It should be understood that the above mentioned views such as the search query view 310, the list view 320, the main menu view 330, the storage status view 340, the file management menu view 350, and the photo search view 360 are not limited by this embodiment, but can be varied depending on requirements.

Various components of the file management system 10 such as the view generating unit 110, the searching unit 120, the selecting unit 130, the processing unit 140, and the storage measuring unit 150 can be can be integrated into a single control unit. Alternatively, such components can also be software instructions written via a variety of software languages, including C, C++, Java, Visual Basic, and many others, and can be executed by hardware such as an FPGA or an ASIC to acquire the above-mentioned functionality of the components.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A file management system for managing a plurality of files stored in a portable electronic device, comprising:
a view generating unit capable of generating a search query view in response to a first user input, the search query view being configured for receiving a search query in response to a second user input;
a searching unit capable of retrieving a plurality of files, if any, matching the search query, and instructing the view generating unit to generate a list view, the list view being configured for listing a plurality of entries each associated with a retrieved file;
a selecting unit for selecting a plurality of listed entries in response to a third user input; and
a processing unit for accessing a plurality of files corresponding to the selected entries, and performing a function on the accessed files in response to a fourth user input.

2. The file management system as claimed in claim 1, wherein the files are stored in conjunction with their metadata, the search query is comparable with the metadata of the files.

3. The file management system as claimed in claim 1, wherein search query view includes a field selected from the group consisting of: file name, file size, resolution, quality, file type and latest revised time.

4. The file management system as claimed in claim 1, wherein each of the entries includes terms included in metadata of the corresponding file.

5. The file management system as claimed in claim 1, wherein the selecting unit is configured for defining a focus point on each selected entry.

6. The file management system as claimed in claim 1, wherein the performed function is a function selected from the group consisting of deleting and renaming.

7. The file management system as claimed in claim 1, further comprising a storage measuring unit, the storage measuring unit being configured for measuring storage status of the portable electronic device, and triggering the view generating unit to generate a view to show the storage status.

8. A file management method for managing a plurality of files stored in a portable electronic device, comprising:
presenting a search query view in response to a first user input;
receiving a search query using the search query view in response to a second user input;
retrieving a plurality of files, if any, matching the search query;
presenting a list view for listing a plurality of entries that satisfy the search query;
selecting a plurality of listed entries in response to a third user input;
accessing a plurality of files associated with the selected entries; and
performing a function on the accessed files in response to a fourth user input.

9. The file management method as claimed in claim 8, wherein the files are stored with metadata, the search query is comparable with the metadata of the files.

10. The file management method as claimed in claim 8, wherein search query view includes a field selected from the group consisting of: file name, file size, resolution, quality, file type and latest revised time.

11. The file management method as claimed in claim 8, wherein each of the entries includes terms included in metadata of the files.

12. The file management method as claimed in claim 8, wherein the performed function is a function selected from the group consisting of deleting and renaming.

13. The file management method as claimed in claim 8, further comprising: presenting a parent menu view of the search query view, the parent menu view being including an option for triggering the search query view, the first user input being a click on the option.
